(19) United States
(12) Patent Application Publication
(10) Pub. No.: US 2006/0219101 A1
(43) Pub. Date: Oct. 5, 2006

(54) Birdcage chicken roasting/grilling machine and accessories

(76) Inventors: Daniel James McIlwee, Irving, TX (US); William Shadwick Genson, Dallas, TX (US)

Correspondence Address: Wilson Daniel Swayze, Jr., 3804 Clearwater Ct., Plano, TX, 75025, US

(21) Appl. No.: 11/372,676

(22) Filed: Mar. 10, 2006

Related U.S. Application Data
(60) Provisional application No. 60/661,118, filed on Mar. 12, 2005.

(51) Int. Cl. A47J 37/04

(52) U.S. Cl. 99/419

(57) ABSTRACT

A system for roasting fowl includes a vertical roaster for supporting the fowl and a detachable handle for carrying the vertical roaster.

### PRIORITY

The present invention claims priority under 35 USC section 119 and is based upon patent application Ser. No. 60/661,118 filed on Mar. 12, 2005.

### BACKGROUND OF THE INVENTION

U.S. Pat. No. 5,081,916 to Kuhling discloses a support element for supporting fowl during storage and for use during cooking processes having an overall conical shape.

U.S. Pat. No. 5,893,320 to Demaree discloses a device for improving the process of cooking fowl in a heated chamber.

U.S. Pat. No. 6,062,131 to Holland discloses a roasting stand adapted for use in imparting flavoring steam to a chicken during the cooking process with an indoor oven or outside grill.

U.S. Pat. No. 6,553,896 to Heide discloses a collapsible cooking stand or apparatus.

Fowl which includes primarily chicken has been a food staple throughout the world for centuries. There are various methods for cooking fowl which includes boiling, under pressure, deep-fried, pan-fried, microwave, barbecued or roasted or any combination. The reason for choosing one method over another is primarily taste which may include the qualities of flavor, tenderness, texture and appearance imported by the cooking process. Various additives may also be used in the process to affect the taste of the cooked fowl such as spices, fruits or vegetables, stuffing, marinades or sauces. The additives desired and ease with which the additives can be applied may also affect the desirability of the different processes. Other factors include simplicity, available equipment, and available material such as oil for deep frying. A great improvement on the process for cooking fowl is the vertical roaster which is a rack that allows the fowl to be placed in a pan or over a grill in the vertical position. While retaining the advantages of regular roasting such as good appearance, and responsive to additives resulting in good flavor and good texture, the vertical roaster allows fat to drain from the fowl during the cooking process resulting in a very low residual fat content. One additive that is particularly popular is commercial beverages. More particularly, the beverages which are available in the standard sized can such as soda and beer. One aspect of the cooking process is separating the fowl from the beverage can. Since the beverage can may not be necessarily empty at the end of the cooking process, the foul and the beverage can must be carefully separated in order to avoid spilling the liquid left in the beverage can and also from contaminating or separating the cooked fowl. While cooking, it may be necessary to turn the fowl in order to achieve a uniform cooked fowl. When the fowl is nearly cooked, the meat is tender and has a potential to fall from the vertical roaster if handled unnecessarily. Furthermore, it is desirable to be able to move the cooked fowl from the location in which the fowl is cooked to the location where the fowl may be prepared for individual serving.

### SUMMARY OF THE INVENTION

A vertical roaster includes a wire frame roasting rack that serves as a mounting surface for a part or whole processed chicken or fowl. The vertical roaster is designed to facilitate the preparation for cooking, transporting to and from the cooking site, cooking, carving and serving of the finished cooked product. A handle is designed to be detachable connected to the vertical roaster so that the handle can be removed while the fowl is being placed on the vertical roaster or when the fowl is cooking. Additionally disclosed is an alternate handle assembly designed to employ a sphere at the apex of the vertical roaster and a lifting tool, a metal cooking tray with a carousel, a cooking pan which may be disposable and may be formed from aluminum foil, and a cuff which may be disposable and may be formed from aluminum foil which when attached to the beverage can will provide stability and increase safety.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the vertical roaster;

FIG. 2 illustrates a perspective view of a cooking tray;

FIG. 3 illustrates a cross-sectional view of a handle;

FIG. 4 illustrates a front view of the handle;

FIG. 5 illustrates a perspective view of the handle;

FIG. 6 illustrates a top view of the handle;

FIG. 7 illustrates a perspective view of the center tray ring;

FIG. 8 illustrates a sectional view of the cooking pan which may be disposable;

FIG. 9 illustrates another perspective view of the cooking tray;

FIG. 10 illustrates a cross-sectional view of a beverage cuff;

FIG. 11 illustrates a top and cross-sectional view of a cutting tray;

FIG. 12 illustrates a cross-sectional view of the vertical roaster;

FIG. 13 illustrates a cross-sectional view of the vertical roaster;

FIG. 14 illustrates a top view of the vertical roaster;

FIG. 15 illustrates a cross-sectional view of another embodiment of the vertical roaster;

FIG. 16 illustrates a top view of the lifting tool;

FIG. 17 illustrates a cross-sectional view of the lifting tool

FIG. 18 illustrates a perspective view of the lifting tool;

FIG. 19 illustrates a cross-sectional view of the prongs of the lifting tool;

FIG. 20 illustrates a perspective view of the vertical roaster; and

FIG. 21 illustrates a reusable cup;

FIG. 22 illustrates a fowl mounted on the vertical roaster.

### DETAILED DESCRIPTION

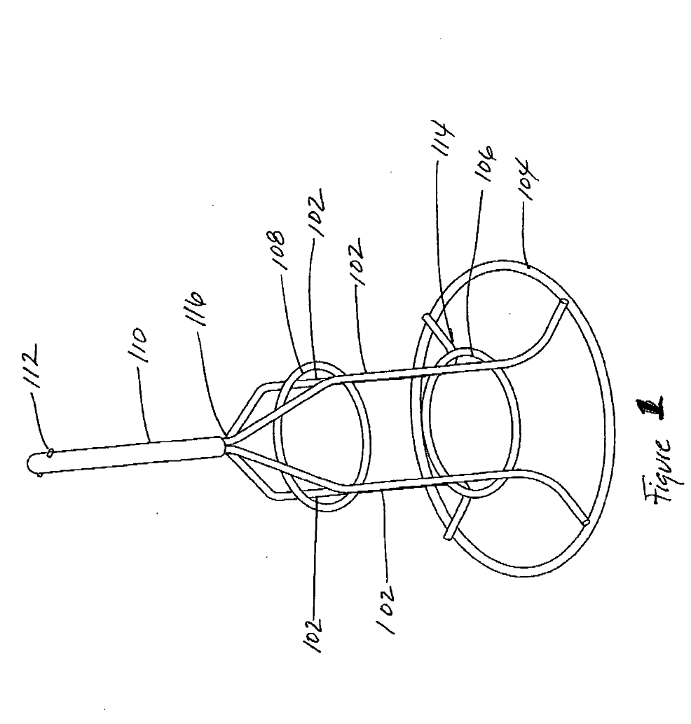

FIG. 1 illustrates a vertical roaster 100 for roasting fowl and other types of food which may be a rigid structure and which may be constructed from steel wire. The vertical roaster 100 is generally shaped as a cage and is referred to as a birdcage. The vertical roaster 100 includes a plurality of supports 102 which are substantially vertical when the vertical roaster 100 is normally positioned. Each of the supports 102 includes an inclined section 112 and a curved section 114 which extends to the base ring 104. The vertical roaster 100 rests on the base ring 104 which is positioned below a center ring 106 which is connected to the support 102 to assist in the stability of the vertical roaster 100. Typically, the center ring 106 has a diameter which is slightly larger than the diameter of a beverage can and which could be sized to any convenient diameter. Additionally, the vertical roaster 100 includes a top ring 108 which is positioned above the center ring 106 and connected to the support 102 to assist in the stability of the vertical roaster 100. The supports 102 come together to form a vertical section 116 which is covered by a sleeve 110. The diameter of the sleeve 110 is sufficiently smaller than the diameter of the vertical roaster 100 to provide for an ‘arrow head’ for the vertical roaster 100 to allow for convenient insertion into the fowl. A traverse pin 112 is positioned near the top of the sleeve 110 to allow for a detachable connection to a handling tool 300 so that the fowl can be moved from one location to another location without removing the fowl from the vertical roaster 100 and also without interfering with the insertion of the fowl onto the vertical roaster 100. The handle 300 can be detached from the vertical roaster 100; the sleeve 110 can be inserted into the fowl, and the fowl can be supported by the supports 102 including the inclined section 112 and the curved section 114. The handle 300 can be reattached to the pin 112 so that the fowl can be moved or turned.

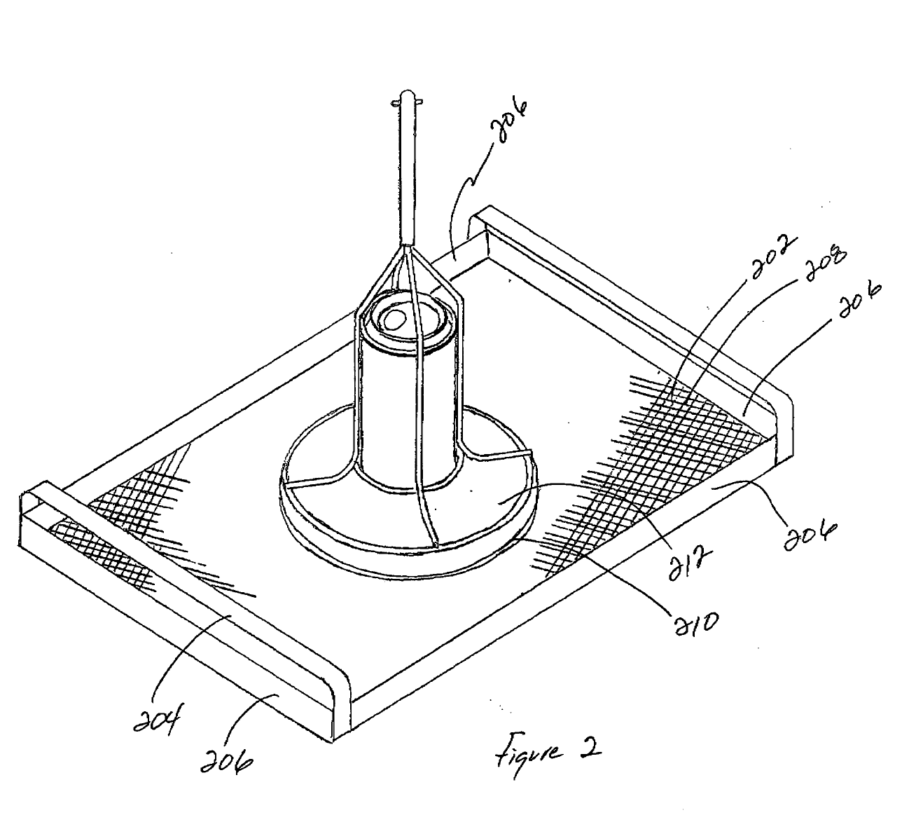

FIG. 2 illustrates a cooking tray 200 which has been adapted to support the vertical roaster 100 and includes a base 202 having holes 208 to allow the liquid such as fat from the fowl to drain from the vertical roaster 100. The cooking tray 200 includes a handle 204 which runs along the width of the cooking tray 200. Furthermore, the cooking tray 200 includes a side section 206 around the periphery of the cooking tray 200 and a tray center ring 210 which allows the vertical roaster 100 to be rotated on a carousel 212 so that the fowl can be evenly cooked.

FIG. 3 illustrates the handle of 300 which can be detachedly connected to the vertical roaster 100 and includes a cylinder 308 having a hand grip 310 at proximal end of the cylinder 308 and having a sleeve 304 at the distal end of the cylinder 308. The cylinder 308 includes a spring mechanism 306 to bias the sleeve 304 to move along the cylinder 308 and to lock the pin 112 of the vertical roaster 100. The sleeve 304 includes a horizontal channel 302 to accept the pin 112 which may be shaped as an inverted t or l and includes a seating pocket 302 to lock the pin 112.

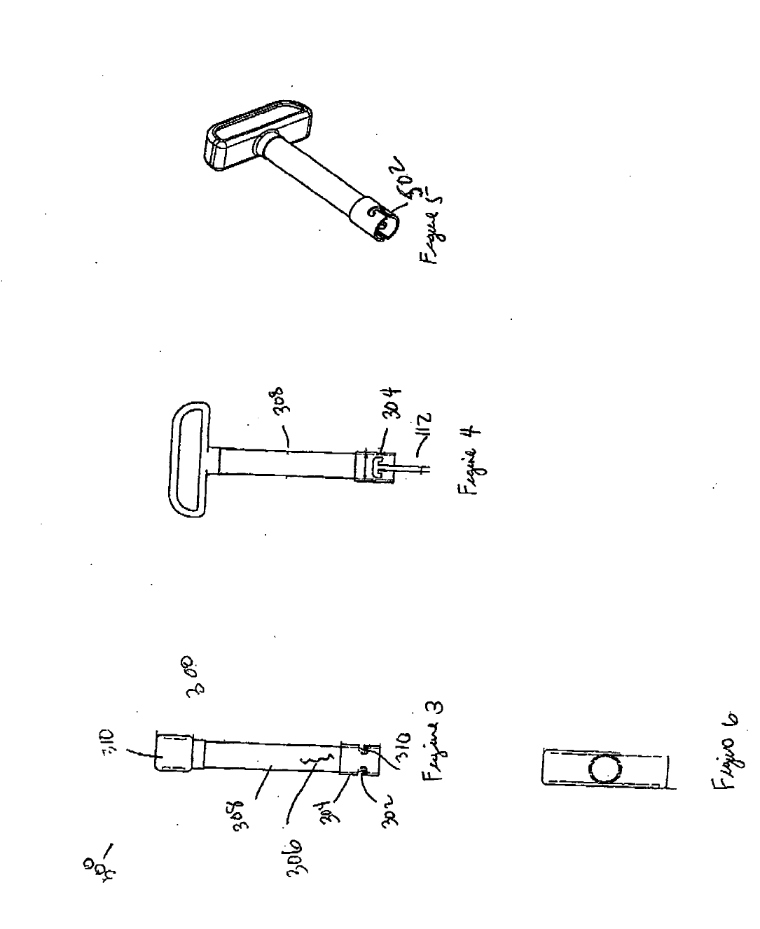

FIG. 4 illustrates the handle 300 and a pin 112.

FIG. 5 illustrates a perspective view of the handle 300 and shows the slot 502 for the pin 112 in the sleeve 304.

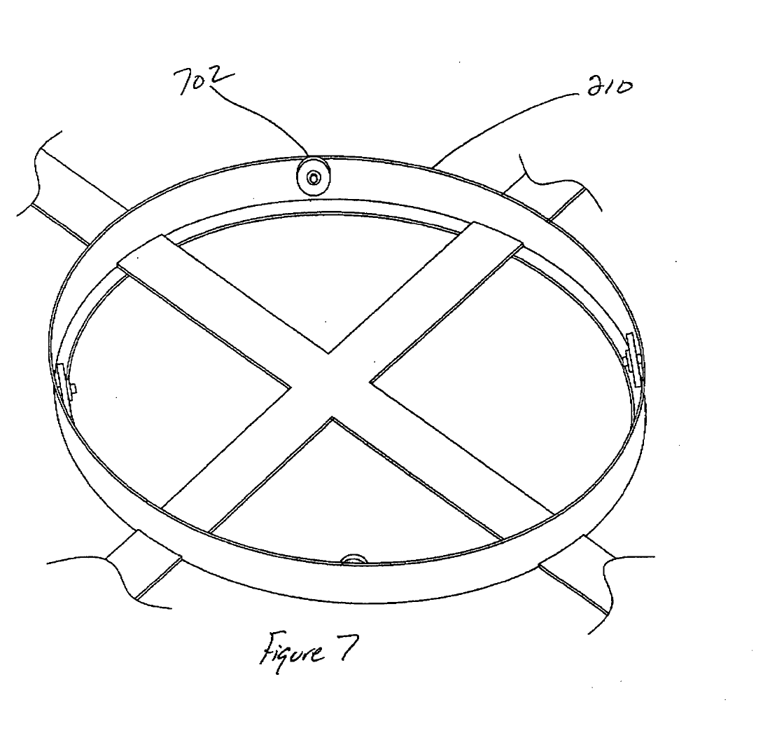

FIG. 6 illustrates a top view of the handle 300.

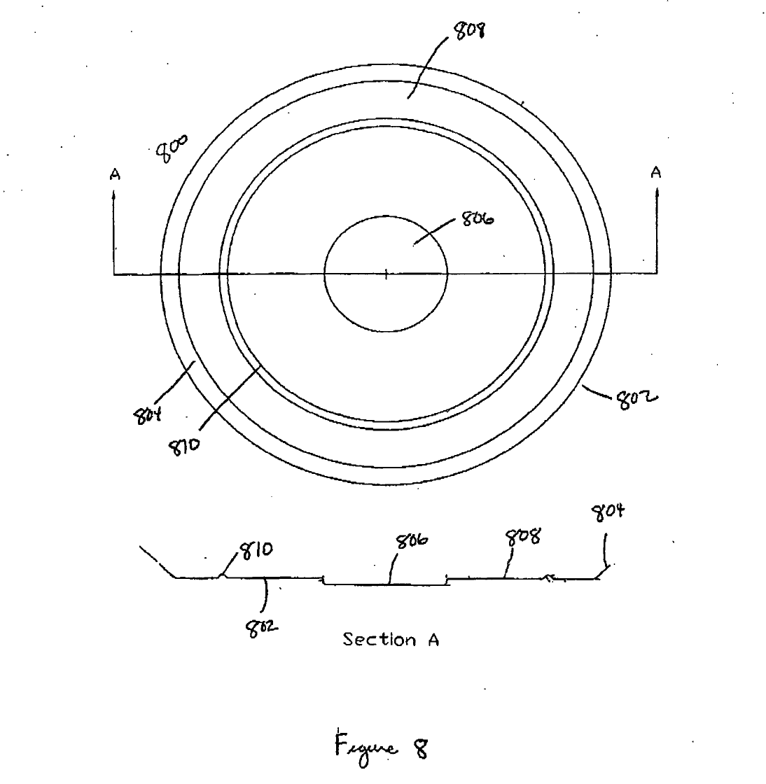

FIG. 7 illustrates a perspective view of the table center ring 210 which shows an apparatus 702 including wheels which may be constructed from Teflon coated stainless steel to turn a carousel or tray.

FIG. 8 illustrates a cooking pan 800 which may be made from disposable aluminum foil to cook the fowl or other types of food. The cooking pan 800 includes a center section 806 having a first diameter adapted to seat a beverage can which may be aluminum, an outer section 802 on a different plane with respect to the center section 806 and which includes an upward projecting element 810 to position the vertical roaster. The upward projecting element 810 is shown as a continuous circle. The outer periphery of the tray 800 is shown including an inclined section 804.

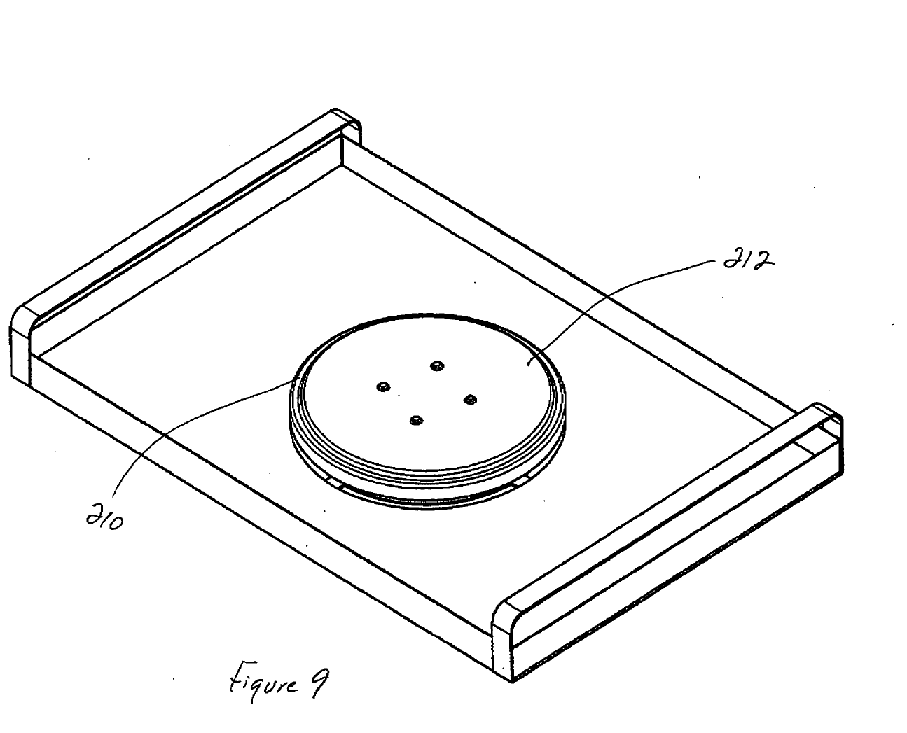

FIG. 9 illustrates a perspective view of the cooking tray 200 with the tray center ring 210 and the carousel 212.

FIG. 10 illustrates a beverage cuff 1000 which may be constructed from disposable aluminum foil having a top surface 1002 having a diameter approximately the diameter of a beverage can and a bottom 1004 having a larger diameter than the top surface 1002 which when placed on the cooking pan 800 will seat inside the upward projecting element 810.

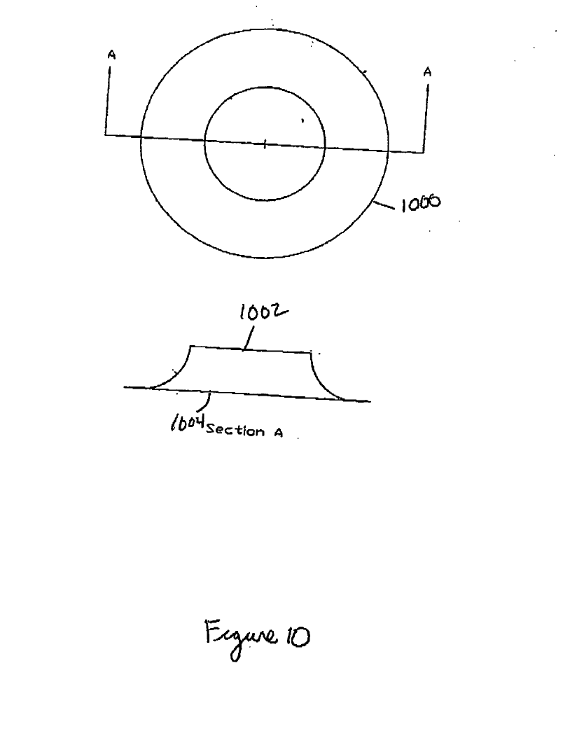

FIG. 11 illustrates a transporting/cutting surface or tray 1100 including the groove 1106 and an inclined segment 1102 positioned on each side of the tray 1100. While the tray 1100 is illustrated as rectangular, other shapes are within the scope of the invention, and the tray 1100 could be constructed from the Lucite, plastic or other appropriate material. Additionally, Lucite or plastic strips could be fastened adjacent to the groove 1106 to form a locking mechanism.

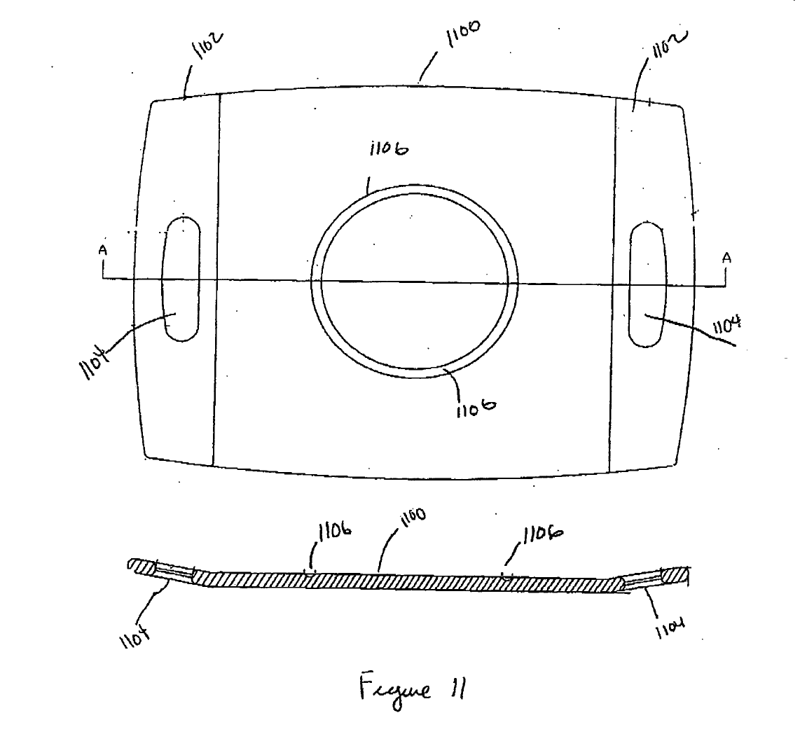

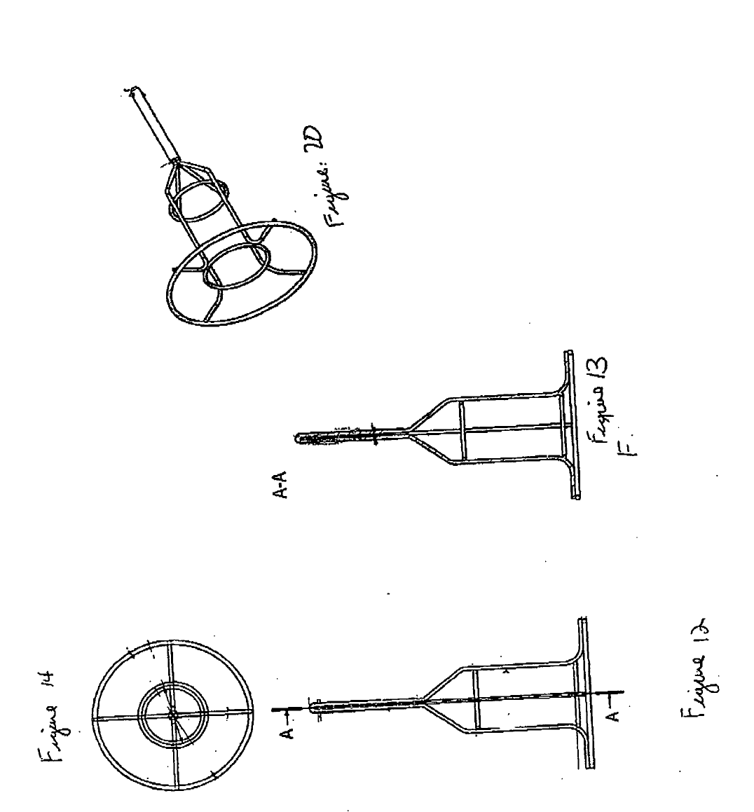

FIG. 12 illustrates a front view of the vertical roaster 100 while FIG. 13 illustrates a sectional view along sectional line A-A. FIG. 14 illustrates a bottom view of the vertical roaster 100 while FIG. 20 illustrates a perspective view of the vertical roaster 100.

FIG. 15 illustrates another embodiment of the vertical roaster 100 having a handle which is detachedly connected to the vertical roaster 100. FIG. 15 illustrates a vertical roaster 1500 which does not include the sleeve 110 as illustrated in FIG. 1. The vertical section 106 of support 102 extends to a sphere 1502 or other suitable device such as a cylinder or rectangle to allow the vertical roaster 1500 to be easily lifted.

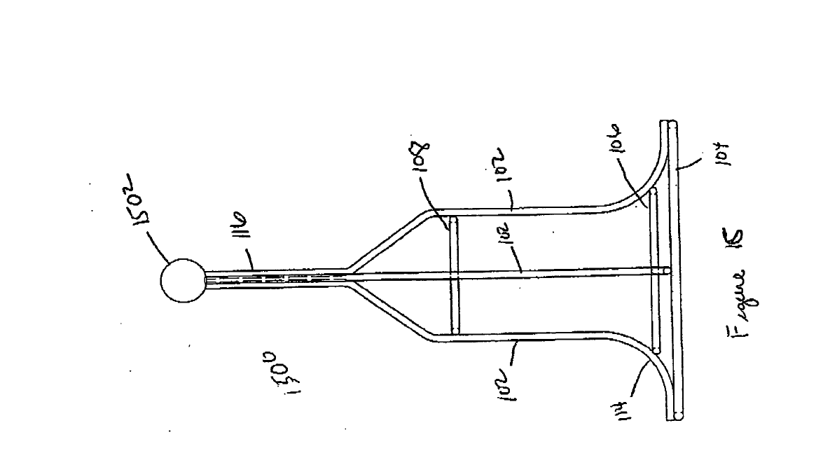

FIG. 16 illustrates a top view of the lifting tool 1600 to lift the vertical roaster 1500 by placing the fork including the prong 1602 of the lifting tool number 1600 under the sphere 1502.

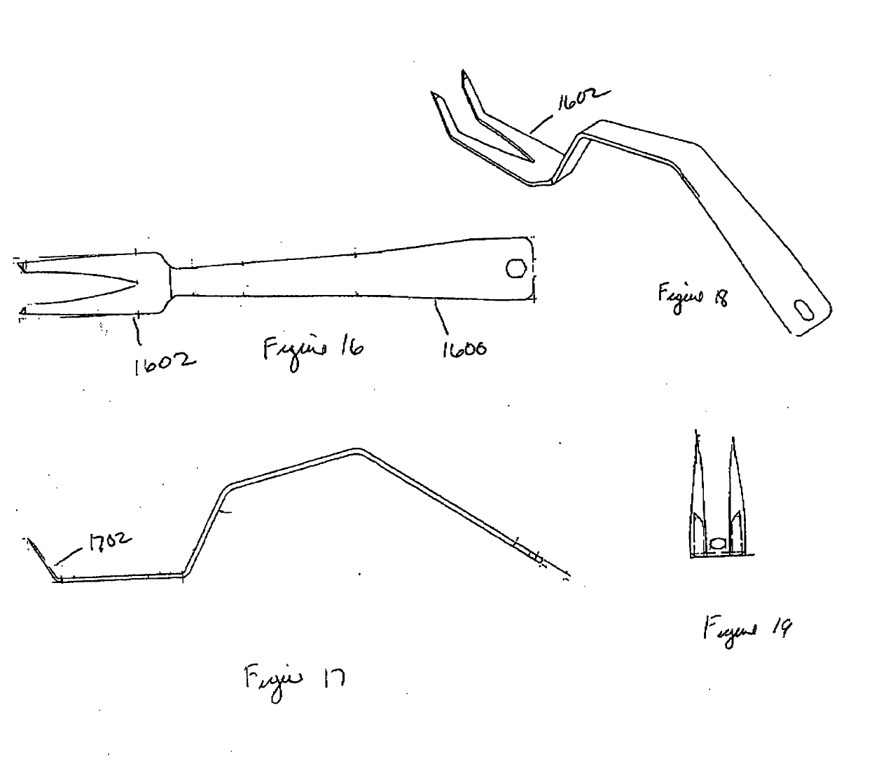

FIG. 17 illustrates a side view of the lifting tool 1600 including an inclined section 1702 of the prong 1602 to prevent the vertical roaster 1500 from slipping off the prong 1602.

FIG. 18 illustrates a perspective view of the lifting tool 1600.

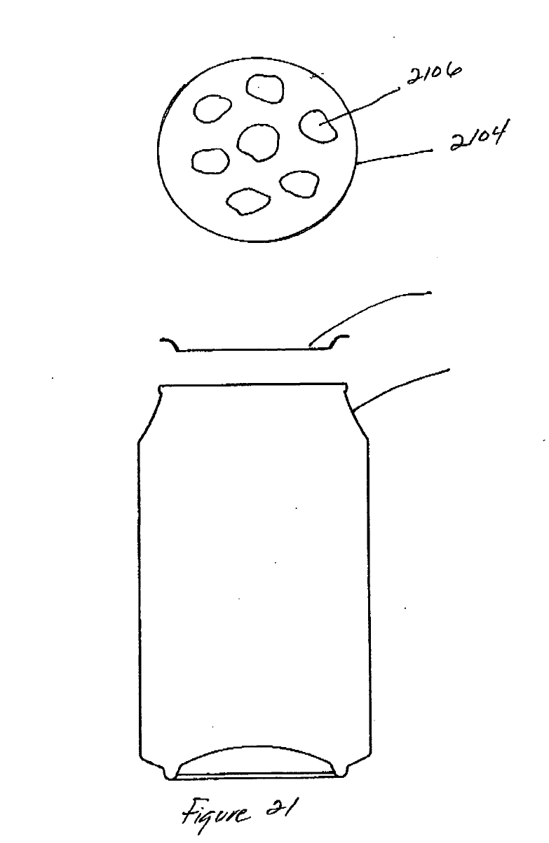

FIG. 19 illustrates the fork 1602.

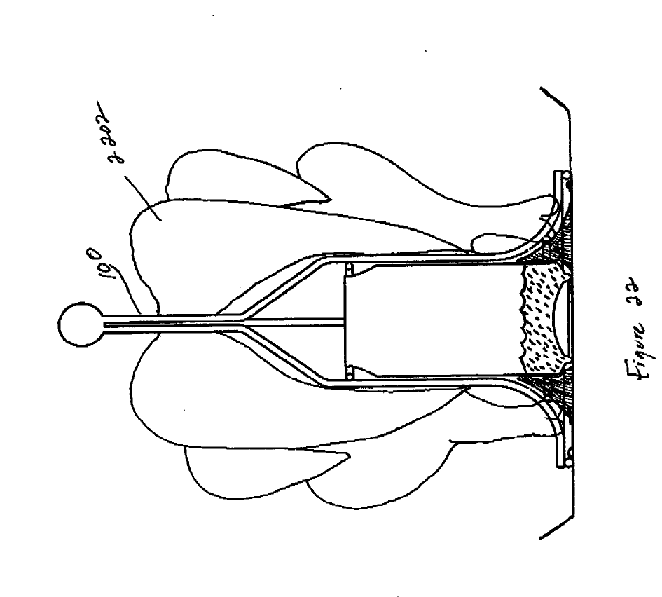

FIG. 21 illustrates a reusable cup 2100 which is similar in shape to a beverage can. The reusable cup 2100 includes a container 2102 for holding a liquid to flavor the fowl and a top 2104 including holes 2106 to allow the liquid to escape from the container 2102.

FIG. 22 illustrates the fowl mounted on the vertical roaster 100 and accessories.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A system for roasting fowl, comprising:
a vertical roaster for supporting said fowl;
a detachable handle for carrying said vertical roaster.

2) A system for roasting fowl as in claim 1, wherein said vertical roaster includes a pin for engaging with said detachable handle.

3) A system for roasting fowl as in claim 2, wherein said detachable handle includes a slot to accept said pin.

4) A system for roasting fowl as in claim 3, wherein said detachable handle includes a sleeve which can be biased to lock said pin.

5) A system for roasting fowl as in claim 4, wherein said sleeve includes a seating pocket for said pin.

6) A system for roasting fowl as in claim 1, wherein said vertical roaster includes a sphere for engaging with said detachable handle.

7) A system for roasting fowl as in claim 6, wherein said detachable handle includes a fork for engaging said sphere.

8) A system for roasting fowl as in claim 1, wherein said system includes a tray to rotate said vertical roaster.

9) A system for roasting fowl as in claim 1, wherein said system includes a disposable aluminum foil cooking pan in a disposable aluminum foil beverage cuff.

10) A system for roasting fowl as in claim 1, wherein said vertical roaster is formed to accept a beverage can by sitting over the beverage can.

11) A system for roasting fowl as in claim 1, wherein said vertical roaster includes a support to support said fowl.

12) A system for roasting fowl as in claim 11, wherein said support includes an inclined section.

13) A system for roasting fowl as in claim 11, wherein said support includes a curved section.

14) A system for roasting fowl as in claim 11, wherein said support includes a base ring.

15) A system for roasting fowl as in claim 11, wherein said support includes a center ring.

16) A vertical roaster for roasting fowl, comprising:
said vertical roaster supporting said fowl;
a detachable handle for carrying said vertical roaster.

17) A vertical roaster for roasting fowl as in claim 16, wherein said vertical roaster includes a pin and wherein said detachable handle includes a sleeve for accepting said pin.

18) A vertical roaster for roasting fowl as in claim 17, wherein said detachable handle includes a slot to accept said pin.

19) A vertical roaster for roasting fowl as in claim number 16, wherein said vertical roaster includes a sphere and said detachable handle includes a fork to accept said sphere.
